(19) United States
(12) Patent Application Publication
(10) Pub. No.: US 2009/0276228 A1
(43) Pub. Date: Nov. 5, 2009

(54) TECHNIQUES FOR INTERNET CAFE SERVICE PROVIDER ACCESS

(76) Inventor: Scott Alan Isaacson, Woodland Hills, UT (US)

Correspondence Address: SCHWEGMAN, LUNDBERG & WOESSNER/NOVELL, PO BOX 2938, MINNEAPOLIS, MN, 55402, US

(21) Appl. No.: 12/112,098

(22) Filed: Apr. 30, 2008

(51) Int. Cl. G06Q 30/00; G06F 9/445; H04L 9/32

(52) U.S. Cl. 705/1; 717/178; 726/16

(57) ABSTRACT

Techniques for Internet café service provider access are presented. An Internet café includes one or more computers that customers use to access the Internet. Each computer of the Internet café is provisioned with a virtual machine (VM), each VM is tailored with a particular operating system (OS) and suite of services. The OS's and suite of services are regularly updated over the Internet via a Internet café service provider to keep the VM's up-to-date via remote administration that is not needed on site at the Internet café.

### BACKGROUND

Although the percentage of households and businesses that have computers and that have access to the Internet steadily continues to rise, many people are still without a dedicated online connection, and thus rely on publicly available “Internet Cafés” for their connection to the digital world. In this model, the users pay a nominal fee to walk into an Internet Café for purposes of accessing the World-Wide Web (WWW) via the Internet.

Even though the cost per session or per hour is relatively small, these individuals expect to have the most recent software applications and features available to them when they access the Internet. They also expect security and privacy. In fact, many individuals have existing Internet connections at home but prefer Internet Cafés because of the privacy and anonymity it is believed these establishments provide. Users also expect to be able to install plug-ins and helper applications, as needed during their session, into the WWW browser or other Internet-aware applications for features that are unique to their individual needs.

On the other hand, the Internet Café owner expects to provide all of these services to its users at the lowest possible cost. The owner does not want to purchase long term licenses for operating systems (OS's) and productivity applications since the Café owners want the flexibility to regularly upgrade and move from application to application based on their local user base. Owners are also concerned about creating a fairly large sandbox to please the customers and allow the customers flexibility in what the customers can access and download. Yet, the sandbox should be small enough to prevent system infection, damage, or application-glut that consume resources and require additional on-site management.

Furthermore, the owners want to minimize the local technical expertise required to install and manage their physical computer systems onsite at their Internet Cafés. The cost associated with providing the Internet access (from the customer perspective) is relatively small, but the expense in managing the hardware and software within the Internet Cafés can be significantly higher because often the Café owners are forced to hire skilled support staff that demands a substantial hourly rate for support and maintenance services.

Consequently, there is a need for improved techniques for providing Internet access in Internet Cafés.

### SUMMARY

In various embodiments, techniques for Internet café service provider access are presented. In an embodiment, a method for Internet café service provider access is presented. An administrator is interacted with over an Internet connection to define a processing environment of one or more computers within an Internet café. Selections are received for an operating system and services from the administrator during the Internet connection. A virtual machine (VM) for the computers of the Internet café is packaged and configured in response to the selections and the defined processing environment. Finally, the VM is dynamically pushed over the Internet connection to the computers and the administrator is instructed to reboot the computers to install and activate the VM. The VM, once activated on the computers, provides customers of the Internet café with access to the Internet via the services.

### BRIEF DESCRIPTION OF THE DRAWINGS

FIG. 1 is a diagram of a method for Internet café service provider access, according to an example embodiment.

FIG. 2 is a diagram of another method for Internet café service provider access, according to an example embodiment.

FIG. 3 is a diagram of Internet café service provider access system, according to an example embodiment.

FIG. 4 is a diagram of another Internet café service provider access system, according to an example embodiment.

### DETAILED DESCRIPTION

A “resource” includes a user, content, a processing device, a node, a service, an application, a system, a gateway, a directory, a data store, a World-Wide Web (WWW) site, an end-user, groups of users, combinations of these things, etc. The terms “service,” “module,” “software,” and “application” may be used interchangeably herein and refer to a type of software resource that includes instructions, which when executed by a machine performs operations that change the state of the machine and that may produce output.

A “client” or “client workstation” is machine (computer, processing device, etc.) that a user uses to access a network. The client includes a processing environment and executes a browser, such as a WWW browser. As used herein the terms “client,” “desktop,” “client machine,” “client workstation,” and “workstation” may be used interchangeably and synonymously.

A “server” is a machine that the client interacts with over a network, such as the Internet. The user, via its browser on the client, attempts to establish a connection with the server or to a resource of the server.

An “Internet café” is a business or enterprise where Internet access is available via computers of that enterprise to customers for a nominal fee or in some instances for free. Thus, any business that provides computers for customers to access the Internet may be viewed as an Internet café. In this sense, even a public library may be viewed as a type of an Internet café.

Various embodiments of this invention can be implemented in existing network architectures, browsers, proxies, agents, storage systems, security systems, data centers, and/or communication devices. For example, in some embodiments, the techniques presented herein are implemented in whole or in part in the Novell® network, proxy server products, email products, operating system products, data center products, and/or directory services products distributed by Novell®, Inc., of Provo, Utah.

Of course, the embodiments of the invention can be implemented in a variety of architectural platforms, operating and server systems, devices, systems, or applications. Any particular architectural layout or implementation presented herein is provided for purposes of illustration and comprehension only and is not intended to limit aspects of the invention.

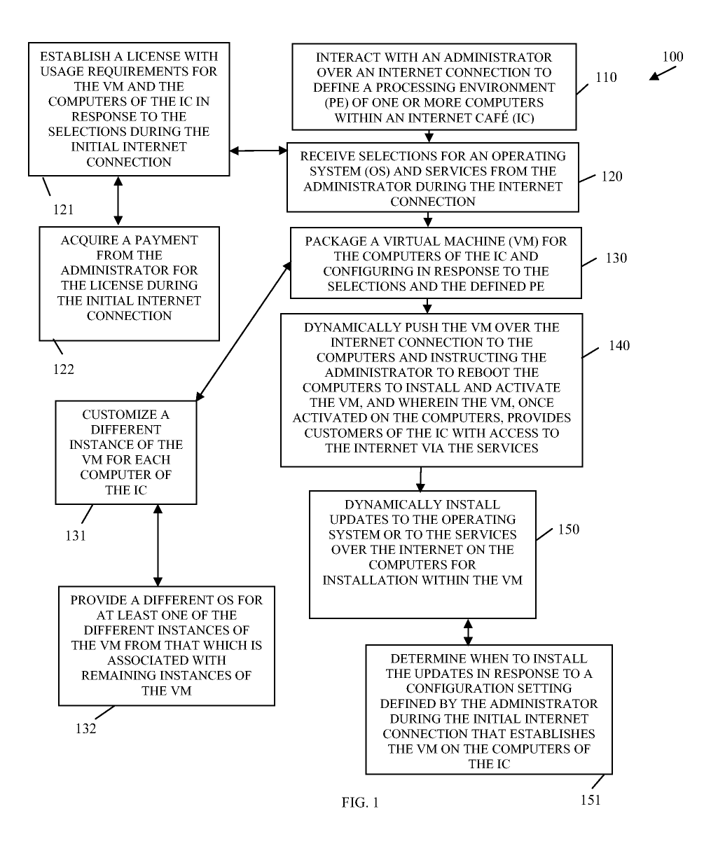

It is within this context, that various embodiments of the invention are now presented with reference to the FIGS. 1-4.

FIG. 1 is a diagram of a method 100 for Internet café service provider access, according to an example embodiment. The method 100 (herein after “Internet café service provider”) is implemented as instructions (within a computer-readable storage medium) that process on a server machine over a network and is accessed from computers of an Internet café via the Internet. The network may be wired, wireless, or a combination of wired and wireless.

At 110, the Internet café service provider initially interacts with an administrator of an Internet café over an Internet connection. This is done for purposes of defining a processing environment for one or more computers located within the Internet café. The administrator may even be an owner or manager of the Internet café, in this sense the term “administrator” is used to identify the resource that initially contacts the Internet café service provider for purposes of provisioning the Internet café computers with virtual machines (VM's) that provide a suite of services and an operating system on the Internet café computers for accessing the Internet. Customers use the computers running the VM's to access the Internet from the Internet café.

At 120, the Internet café service provider receives a variety of selections for an operating system and services from the administrator during the Internet connection. So, the administrator identifies the operating system (OS) to run with the VM, such as but not limited to Novell's Suse® Linux OS. The administrator also identifies a suite of services that are to be available to customers the run the VM. Some example services may include World-Wide Web (WWW) browser, such as but not limited to Mozilla Firefox®. Other services may include a basic email client, plugins for the WWW browser, graphics processing applications, document editors, spreadsheet applications, etc. In fact, the entire environment can be defined for the VM by the administrator during the initial Internet connection.

Essentially, within the environment of the Internet café service provider and remote from the Internet café, the Internet café service provider hosts a variety of VM's that may be of interest to a particular Internet café and administrator that interacts with the Internet café service provider. For example, the Internet café service provider can have available for configuration within any particular VM the latest platform for Windows® OS, which include productivity applications, WWW connectivity applications, multimedia applications. The Internet café service provider may also include the latest Linux distros platform with K Desktop environment (KDE), productivity applications, WWW applications, multimedia applications, etc.

The administrator can define the hardware of the Internet café computer(s) as described at 110; alternatively the selections made during the Internet connection with the administrator can be used by the Internet café service provider to suggest a preferred or minimal hardware configuration. In some cases, the administrator can even order hardware and rent it from an enterprise that is associated with the Internet café service provider. So, the Internet café service provider enterprise can also be a hardware reseller in some cases.

Also, the selections made at 120 may be restricted based on the definition of the processing environment supplied by the administrator at 110. That is, some services desired may not be available based on the OS or hardware limitations of the Internet café computer and the Internet café's processing environment.

According to an embodiment, at 121, the Internet café service provider also establishes a license with usage requirements for the VM and the computers/processing environment of the Internet café. The license can be tailored based on the sections made by the administrator at 120. Before proceeding with defining and acquiring the VM, the administrator can be made to accept the licensing terms presented. The license can include a variety of sub licenses, so that each selected service and the operating system is covered.

In some cases, at 121, the Internet café service provider also acquires a payment from the administrator for the license and the software associated with the VM (operating system and service selections). Payment can be received via a credit card transaction, debit card, electronic bank check, funds transfer, or even via a third-party service such as PayPal®. In some instances, an invoice may be sent to the Internet café and payment may be deferred if a particular Internet café is considered to be credit worthy such that credit can be extended.

At 130, the Internet café service provider packages a VM for the computers of the Internet café. The VM is configured in response to the selected operating system, processing environment definitions, and service selections. The VM is a self contained software package that acts as if it is an independent computer and independent processing environment once installed on computers of the Internet café.

Included with the VM package is an agent that can interact with the Internet café service provider once installed and up and running on the computers of the Internet café. The agent can be used for a variety of purposes, such as automatic updates to the OS and the services; reporting for licensing compliance, advertisements to acquire additional or updated enhance services, etc.

In an embodiment, at 131, the Internet café service provider customizes a different instance of the VM for each particular computer identified in the processing environment or local area network (LAN) of the Internet café. So, a single Internet café can include several different OS's, service configurations, etc. The administrator can interact with the Internet café service provider via the Internet connection to define each particular computer and a particular VM that it wants to have on those computers. It may also be that the Internet café has a single computer that includes multiple different VM's, such that the computer can be booted up in response to a login to install and run a particular desired VM on that computer. Thus, multiple VM's can span multiple computers of the Internet café and multiple VM's can co-exist on a single computer of the Internet café.

In a particular situation, at 132, the Internet café service provider provides a different OS for at least one of the different instances of the VM from that which is associated with remaining instances of the VM. So, each VM can have its own and different OS. This may be useful based on the services customers of the Internet café desire to use or may be done for financial reasons, since Linux is an open source OS it can be provided fee or at a much smaller price than Windows®. However, some Internet café's may desire to have at least one VM that runs Windows® because some customers may have devices or services that rely on Windows'® based applications. The point is that each VM can include its own unique OS and each VM is its own logical machine and processing environment.

At 140, the Internet café service provider dynamically pushes or provisions over the Internet connection and to the computers of the Internet café the VM, which was configured in response to the processing environment definitions, operation system desired, and service selections. The Internet café service provider also instructs the administrator to reboot or restart the computers to install and activate the VM. The VM once activated on the computers of the Internet café provide customers of the Internet café with access to the Internet via the computers of the Internet café.

At this point, an Internet café has essentially outsourced the software support and maintenance in an automated fashion to the Internet café service provider. The software provides customers of the Internet café with access to the WWW and Internet while those customers frequent the Internet café. In this manner, the Internet café does not have to contract or hire employees to support and maintain its software for its computers. Should the VM become corrupt it can be fully restored over the Internet to the computers via an Internet connection with the Internet café service provider. The initial OS and software of the Internet café can be maintained and never made available to the customers, such that on boot up this can always be recovered by an administrator and used to contact the Internet café service provider for purposes of either upgrade, fixing, or re-installing a VM to the computers of the Internet café.

According to an embodiment, at 150, the Internet café service provider dynamically installs updates to the OS and services of the VM over the Internet and on the computers of the Internet café. The frequency with which agents (that are pre-installed with the VM) contact the Internet café service provider for updates can be configured by the administrator. Alternatively, updates can be automatically checked on boot up or can be manually requested by an administrator at any time. An example update schedule may occur every night at 2:00 am when the Internet café is not open for use. Other examples exist as well, and it is noted that the time, frequency, and manner in which updates are requested for the VM can be configured and controlled by the Internet café via configurations to the VM made by the Internet café service provider.

So, at 151, the Internet café service provider can determine when to install the updates in response to configuration settings defined by the administrator during the initial Internet connection that establishes the initial VM on the computers of the Internet café. The administrator may also subsequently alter the configuration settings if conditions or needs of the Internet café changes.

One now appreciates how an Internet café can more efficiently supply a variety of services to its customers via VM's that are automatically acquired and configured over the Internet. The support and maintenance of these VM's are also outsourced and automated via the Internet café service provider. In some cases, a pricing schedule may also be provided to customers such that different VM's with more or enhanced services can be used at higher prices. So, the customers get a variety of options based on their needs and the Internet café reduces expense associated with providing these services. In some cases, the VM's may even be provided via the Internet café service provider to the Internet café on a per usage bases, such that there is no fee for the VM's but transaction fees are levied each time usage of a VM or its particular services occur. In fact, the computers of the Internet café can even be rented. This provides for enhanced customer experiences while frequenting the Internet café and substantially reduces support and maintenance and expense associated with an Internet café providing these services.

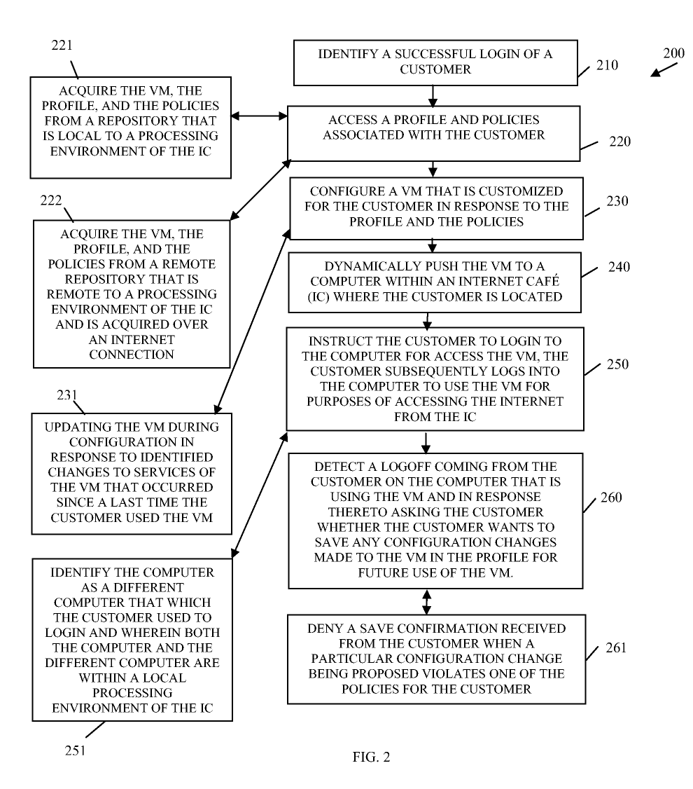

FIG. 2 is a diagram of another method 200 for Internet café service provider access, according to an example embodiment. The method 200 (herein after “Internet café virtual machine (VM) service”) is implemented as instructions (within a computer-readable storage medium) that process on a server machine over a network and is accessed from one or more computers of an Internet café via the Internet. The network may be wired, wireless, or a combination of wired and wireless.

The Internet café VM service presents another perspective of the Internet café service provider presented in detail with reference to the method 100 of the FIG. 1. In some cases, the Internet café VM service provides an enhanced perspective to the method 100 of the FIG. 1.

At 210, the Internet café VM service identifies a successful login of a customer occurring from an Internet café over the Internet and from a processing environment associated with the Internet café. So, the login screen of a computer within the Internet café can be preconfigured within a particular VM implementation, such that on login by a customer of the Internet café the Internet café VM service receives notice.

At 220, the Internet café VM service access a profile and policies associated with the customer. In some cases, a customer that logs in does not already have an account and uses a generic login ID and password to successfully login. In these cases, the customer may be required to register, establish a unique ID and password combination and initially establish a profile. The policies can be generic to all customers or specific to different levels of customers, such that higher paying customers have more liberal policies and greater access then lower paying customers. In other words, different levels of customers can be used to identify different policy sets that are enforced.

In an embodiment, at 221, the Internet café VM service acquires the VM, the profile, and the policies from a repository that is local to the processing environment of the Internet café. In other words, the profiles and policies can be managed locally within the Internet café's LAN.

In other cases, at 222, the Internet café VM service acquires the VM, the profile, and the policies from a remote repository that is remote to a processing environment of the Internet café and that is acquired over an Internet connection. So, here the profiles and policies can be managed externally and hosted outside the Internet café.

In some instances, a combination of local profiles and policies can remote profiles and policies can be used.

At 230, the Internet café VM service configures a VM that is customized for the customer in response to the profile and the policies. So, a customized VM may include particular files and particular services that a customer desires, such as extra enhanced plugins for the WWW browser supplied with the VM, bookmarks of the customer, etc.

In an embodiment, at 231, the Internet café VM service updates the VM during configuration of the VM in response to identified changes to services of the VM that occurred since a last time the customer used the VM. So, updates can occur to services of the VM during the configuration stage and before the VM is customized and provisioned to the computer of the Internet café for the customer to use.

At 240, the Internet café VM service dynamically and in real time pushes the VM to a computer within the Internet café where the customer is located.

According to an embodiment, at 250, the Internet café VM service also instructs the customer to login to a particular computer within the Internet café for accessing the VM that was customized and provisioned for that particular customer. The customer subsequently logs into that computer to use the VM for purposes of accessing the Internet from the Internet café utilizing the services and settings associated with that customer's profile.

In an embodiment, at 251, the Internet café VM service identifies the computer as a different computer than that which the customer is presently using to interact with the Internet café VM service and that which the customer used to login. Both the computer and the different computer are within a local processing environment or LAN of the Internet café.

In some cases, the customer may be using the computer that the VM is being provisioned to. In such cases, the Internet café VM service can automatically notify the customer that the computer is going to reboot and when it does the customer will be able to login to the desired VM on that computer the customer is presently using.

In one situation, at 260, the Internet café VM service detects a logoff coming from the customer on the computer that is using the provisioned VM and in response thereto the customer is asked whether the customer wants to save any configuration changes made to the VM in the profile of the customer for future use of that VM. The customer may elect to forgo the changes or may elect to keep the changes.

However, at 261, and in a particular circumstance the Internet café VM service denies a save confirmation received from the customer when a particular configuration change being proposed by the customer violates one of the policies for the customer. So, suppose the customer did not pay for enhanced services that permitted videos and large storage to be maintained when the session with the VM ends, even if the customer attempts to save such things at the conclusion of the VM session, policy enforcement will not allow the save. It may be in this particular situation that the customer is given the opportunity on logoff to upgrade to an enhanced service plan where the save can be permitted. In other situations, for legal reasons or privacy reasons may have policies that prevent certain types of information from being maintained when the session ends, such as WWW browsing cache or history. So, policy can be enforced at logoff in addition to login. Moreover, as noted above the policy can be locally acquired and administered from the Internet café processing environment and/or can be remotely acquired and administered over the Internet.

The processing associated with the Internet café VM service can be used to provide customized VM's on computers of an Internet café that are tailored to specific customers or classes of customers. As an example consider the following scenario.

A customer walks into an Internet café and logs into a web portal associated with the Internet café VM service with his/her customer ID and credentials. The Internet café VM service finds the profile and policies associated with the customer and associates a specific VM image with that customer that is unique to that customer.

The Internet café VM service provisions a particular computer within the Internet café with the VM image and informs the customer that the VM of interest is being provisioned for the customer on Internet café computer number N (where N is some Integer or label that unique identifies a particular Internet café computer). The customer can now go to computer number 5 and use their VM and the VM image can follow the customer from Internet café to Internet café. Once the customer is finished at the Internet café with the VM and its session, a new and modified VM image can be saved (as discussed above). In this way, unique and personal VM's can follow particular users/customers. In some cases, a single customer can have multiple different VM's where each VM is customized for a particular Internet café (in this case the VM's may be locally administered within the Internet cafés).

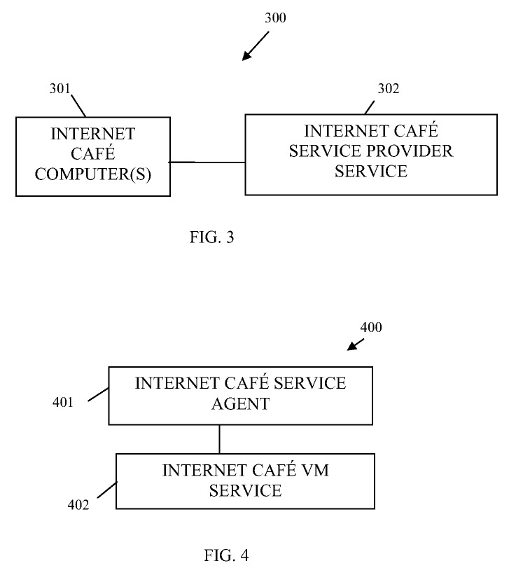

FIG. 3 is a diagram of an Internet café service provider access system 300, according to an example embodiment. The Internet café service provider access system 300 is implemented as instructions on or within a machine-accessible and computer-readable storage medium. The instructions when executed by machines (computers or processor-enabled devices) of a network (such as the Internet) perform, among other things, processing depicted with respect to the methods 100 and 200 of the FIGS. 1 and 2, respective. The Internet café service provider access system 300 is also operational over a network, and the network may be accessed via a wired connection, a wireless connection, or a combination of wired and wireless connections.

The Internet café service provider access system 300 includes an Internet café computer 301 and an Internet café service provider service 302. Each of these and their interactions with one another will now be discussed in turn.

The Internet café computer 301 is processes within a local area network (LAN) of an Internet café. The LAN can include a variety of other Internet cage computers 301. Each Internet café computer 301 is capable of accessing a wide are network (WAN), such as the Internet. Example processing activities associated with the Internet café computer 301 was provided above with reference to the methods 100 and 200 of the FIGS. 1 and 2, respectively.

The Internet café computer 301 is configured by the Internet café service provider service 302 to process a single or multiple different VM's. Each VM provides a particular OS and a particular suite of services. Customers of the Internet café use the Internet café computer 301 to process the VM's while at the Internet café to gain access to the WWW via the Internet.

In an embodiment, an administrator uses the Internet café computer to initially contact the Internet café service provider service 302 over the Internet to provide configuration settings for the VM's. The administrator can also establish a license for the VM's over the Internet via the Internet café computer 301 and pays for the license.

According to an embodiment, a particular customer subsequently logs into the Internet café computer 301 and in response to an authenticated customer identity for the particular customer a particular one of the VM's is booted up and provided to the particular customer for access to the Internet via the Internet café computer 301.

In some cases, the particular customer is instructed by the Internet café service provider service 302 to logoff the Internet café computer 301 and access another Internet café computer 301 within the LAN for purposes of gaining access to the particular VM that the particular customer is to use for accessing the Internet. The particular VM is acquired, configured, and customized in response to the authenticated customer identity. So, the VM is customized for the particular customer.

The Internet café service provider service 302 is implemented as instructions within a computer-readable storage medium and processes on a server. The Internet café service provider service 302 is remotely located over the Internet from the Internet café computer 301. In other words the Internet café service provider service 302 is not within the LAN of the Internet café but is rather a remote service that each Internet café computer 301 can access via an Internet connection from the LAN. Example processing associated with the Internet café service provider service 302 was provided in detail above with reference to the methods 100 and 200 of the FIGS. 1 and 2, respectively.

Again, the Internet service provider service 302 is used to provision in an automated and remote manner VM's to Internet café computers 301 associated with an Internet café. The Internet café is any enterprise that makes computers available to customers for purposes of accessing the Internet while at that enterprise. Access can be free or can be paid for. Moreover, different levels of access can be achieved with different services in response to pay levels of the customers. The Internet service provider service 302 offloads administration associated with providing Internet access to customers. In some cases, the actual Internet café computers 301 can also be acquired and rented from external sources. Moreover, access can be transactional based and passed on to the using customers, such that in some situations the Internet café expends no money or resources to provide the service to customers.

FIG. 4 is a diagram of another Internet café service provider access system 400, according to an example embodiment. The Internet café service provider access system 400 is implemented as instructions on or within a machine-accessible and computer-readable storage medium. The instructions when executed by machines (computers or processor-enabled devices) of a network (such as the Internet) perform, among other things, processing depicted with respect to the methods 100 and 200 of the FIGS. 1 and 2, respectively. The Internet café service provider access system 400 is also operational over a network, and the network is wired, wireless, or a combination of wired and wireless. The Internet café service provider access system 400 presents another and in some cases enhanced perspective of the Internet café service provider access system 300 represented by the FIG. 3.

The Internet café service provider access system 400 includes an Internet café service agent 401 and an Internet café virtual machine (VM) service 402. Each of these and their interactions with one another will now be discussed in turn.

The Internet café service agent 401 is implemented in a machine-accessible and computer-readable storage medium as instructions that process on one or more Internet café computers organized within a LAN of an Internet café.

The Internet café service agent 401 interacts with the Internet café VM service 402 to configure and install one or more VM's on the Internet café computer and on other Internet café computers.

Each VM includes its own particular OS and suite of services for customers of the Internet café to use when access the Internet from the Internet café.

In an embodiment, the Internet café service agent 401 periodically interacts with the Internet café VM service 402 to keep the suite of services updated with each of the VM of the Internet café computer and the other Internet café computers.

In a particular case, the Internet café service agent 401 maintains a remote repository for housing the VM with the assistance of the Internet café VM service 402 and acquires and provisions particular VM's on the Internet café computer or one of the other Internet café computers for a particular customer. The particular VM is customized for the particular customer.

Additionally, in some situations, the Internet café service agent 401 maintains a local repository for housing the VM's on the Internet café computer or one of the other Internet café computers for a particular customer. The particular VM is customized for the particular customer.

The Internet café VM service 402 is implemented in a machine-accessible and computer-readable storage medium as instructions that process on a server machine over the Internet. The Internet café VM service 402 is remote from the LAN of the Internet café and its processing environment. Example processing associated with the Internet café VM service 402 was presented in detail above with reference to the methods 100 and 200 of the FIGS. 1 and 2, respectively.

Again, the Internet café VM service 402 is used to configure, manage, and provision VM remotely over the Internet to Internet café computers associated with an Internet café.

One now fully appreciates how an Internet café can entirely outsource its maintenance and support associated with supplying Internet access to its customers. Moreover, specific VM's can be customized for particular customers.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. § 1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A machine-implemented method, comprising:
interacting with an administrator over an Internet connection to define a processing environment of one or more computers within an Internet café;
receiving selections for an operating system and services from the administrator during the Internet connection;
packaging a virtual machine (VM) for the computers of the Internet café and configuring in response to the selections and the defined processing environment; and
dynamically pushing the VM over the Internet connection to the computers and instructing the administrator to reboot the computers to install and activate the VM, and wherein the VM, once activated on the computers, provides customers of the Internet café with access to the Internet via the services.

2. The method of claim 1 further comprising, dynamically installing updates to the operating system or to the services over the Internet on the computers for installation within the VM.

3. The method of claim 2, wherein dynamically installing further includes determining when to install the updates in response to a configuration setting defined by the administrator during the initial Internet connection that establishes the VM on the computers of the Internet café.

4. The method of claim 1, wherein receiving further includes establishing a license with usage requirements for the VM and the computers of the Internet café in response to the selections during the initial Internet connection.

5. The method of claim 4 further comprising, acquiring a payment from the administrator for the license during the initial Internet connection.

6. The method of claim 1, wherein packaging further includes customizing a different instance of the VM for each computer of the Internet café.

7. The method of claim 6, wherein customizing further includes providing a different operating system for at least one of the different instances of the VM from that which is associated with remaining instances of the VM.

8. A machine-implemented method, comprising:
identifying a successful login of a customer;
accessing a profile and policies associated with the customer;
configuring a VM that is customized for the customer in response to the profile and the policies;
dynamically pushing the VM to a computer within an Internet café where the customer is located; and
instructing the customer to login to the computer for access the VM, wherein the customer subsequently logs into the computer to use the VM for purposes of accessing the Internet from the Internet café.

9. The method of claim 8, wherein accessing further includes acquiring the VM, the profile, and the policies from a repository that is local to a processing environment of the Internet café.

10. The method of claim 8, wherein accessing further includes acquiring the VM, the profile, and the policies from a remote repository that is remote to a processing environment of the Internet café and is acquired over an Internet connection.

11. The method of claim 8, wherein configuring further includes updating the VM during configuration in response to identified changes to services of the VM that occurred since a last time the customer used the VM.

12. The method of claim 8, wherein instructing further includes identifying the computer as a different computer that which the customer used to login and wherein both the computer and the different computer are within a local processing environment of the Internet café.

13. The method of claim 8 further comprising, detecting a logoff coming from the customer on the computer that is using the VM and in response thereto asking the customer whether the customer wants to save any configuration changes made to the VM in the profile for future use of the VM.

14. The method of claim 13, wherein detecting further includes denying a save confirmation received from the customer when a particular configuration change being proposed violates one of the policies for the customer.

15. A machine-implemented system, comprising:
an Internet café computer that processes within a local area network (LAN) of an Internet café and that access the Internet; and
an Internet café service provider service implemented on and to process on a server, wherein the Internet café service provider service is remotely located over the Internet from the LAN and the Internet café computer;
wherein the Internet café computer is configured by the Internet café service provider service to process one or more virtual machines (VM's), each VM providing a particular operating system (OS) and a particular suite of services, and wherein customers of the Internet café use the Internet café computer to process the VM's while at the Internet café to gain access to the World-Wide Web (WWW) via the Internet.

16. The system of claim 15, wherein an administrator uses the Internet café computer to initially contact the Internet café service provider service over the Internet to provide configuration settings for the VM's.

17. The system of claim 16, wherein the administrator establishes a license for the VM's over the Internet via the Internet Café computer and pays for the license.

18. The system of claim 15, wherein a particular customer subsequently logs into the Internet café computer and in response to an authenticated customer identity for the particular customer a particular one of the VM's is booted up and provided to the particular customer for access to the Internet via the Internet café computer.

19. The system of claim 18, wherein the particular customer is instructed by the Internet café service provider service to logoff the Internet café computer and access another Internet café computer within the LAN to gain access to the particular VM that the particular customer is to use for accessing the Internet.

20. The system of claim 19, wherein the particular VM is acquired, configured, and customized in response to the authenticated customer identity.

21. A machine-implemented system, comprising:
an Internet café service agent implemented within an Internet café computer and processing within a local area network (LAN) of an Internet café; and
an Internet café virtual machine (VM) service implemented on a server machine over the Internet and remote from the LAN;
wherein the Internet café service agent interacts with the Internet café VM service to configure and install one or more VM's on the Internet café computer and on other Internet café computers, each VM including a suite of services for customers of the Internet café to use when accessing the Internet from the Internet café.

22. The system of claim 21, wherein the Internet café service agent periodically interacts with the Internet café VM service to keep the suite of services updated within the VM's of the Internet café computer and the other Internet café computers.

23. The system of claim 21, wherein the Internet café service agent maintains a remote repository for housing the VM's with the assistance of the Internet café VM service and acquires and provisions particular VM's on the Internet café computer or one of the other Internet café computers for a particular customer, wherein the particular VM is customized for the particular customer.

24. The system of claim 21, wherein the Internet café service agent maintains a local repository for housing the VM's within the LAN and acquires and provisions particular VM's on the Internet café computer or one of the other Internet café computers for a particular customer, wherein the particular VM is customized for the particular customer.
